(19) United States
(12) Patent Application Publication
(10) Pub. No.: US 2026/0331126 A1
(43) Pub. Date: Oct. 22, 2026

(54) AUDIO PROCESSING DEVICE, AUDIO PROCESSING METHOD, AND IN-VEHICLE SYSTEM

(71) Applicant: HONDA MOTOR CO., LTD., Tokyo (JP)

(72) Inventor: Tomoaki Nakayama, Wako-shi (JP)

(21) Appl. No.: 19/468,281

(22) Filed: Feb. 3, 2026

(30) Foreign Application Priority Data
Mar. 27, 2025 (JP) 2025-054441

(51) Int. Cl. G10L 25/63; G10L 13/027; G10L 15/22; G10L 15/26

(52) U.S. Cl. CPC G10L 25/63; G10L 15/22; G10L 15/26; G10L 13/027

(57) ABSTRACT

An audio processing device includes a speech output portion outputting to a user a speech content generated by a speech content generating portion; an audio recording portion recording a piece, of audio data, including an utterance by the user to the speech content; an emotion recognition portion recognizing an emotion of the user based on at least the piece of the audio data recorded, the emotion of the user being associated with the utterance by the user; a saving portion saving the emotion of the user recognized and the piece of the audio data recorded which is saved corresponding to the emotion of the user; and a speech model generating portion generating a speech model for outputting speech associated with an emotion of the user, based on the audio data and emotions of the user saved with each piece of the audio data corresponding to one of the emotions.

### INCORPORATION BY REFERENCE

The present application claims priority under 35 U.S.C. § 119 to Japanese Patent Application No. 2025-054441 filed on Mar. 27, 2025. The content of the application is incorporated herein by reference in its entirety.

### BACKGROUND OF THE INVENTION

### Field of the Invention

The present disclosure relates to an audio processing device, an audio processing method, and an in-vehicle system.

### Description of the Related Art

Recently, research and development have been underway to acquire information such as user speech data to assist users. Japanese Patent Laid-Open No. 09-171396 discloses a technology for extracting emotional features from audio data for storage in a voice dictionary and referencing an emotional portion of the dictionary to synthesize emotional speech.

Incidentally, the technologies related to providing support for human actions present an issue in providing more realistic speech output. However, the conventional technology cited above involves time and effort to read aloud a script while recording it to create a voice dictionary for speech synthesis. Furthermore, reading a script leads to a lack of realistic emotional expression, resulting in a failure in readily providing realistic speech output.

To solve the issue described above, the present application has an object of readily providing realistic speech output and thereby contributing to supporting human actions.

### SUMMARY OF THE INVENTION

An aspect for achieving the object described above is the audio processing device including: a speech content generating portion configured to generate speech content to be addressed to a user; a speech output portion configured to output to the user the speech content generated; an audio recording portion configured to record a piece of audio data, the piece of the audio data including an utterance made by the user in reply to the speech content; an emotion recognition portion configured to recognize an emotion of the user on a basis of at least the piece of the audio data recorded, the emotion of the user being associated with the utterance made by the user in reply to the speech content; a saving portion configured to save the piece of the audio data recorded and the emotion of the user recognized, the piece of the audio data being saved corresponding to the emotion of the user; and a speech model generating portion configured to generate a speech model for outputting speech associated with an emotion of the user, on the basis of the audio data and emotions of the user saved with each piece of the audio data corresponding to one of the emotions.

In the aspect described above, realistic speech output can be readily provided.

### BRIEF DESCRIPTION OF THE DRAWINGS

FIG. 1 is a block diagram describing an example configuration of the audio processing device according to an embodiment;

FIG. 2 is a diagram for describing an example of Russell's circumplex model of affect;

FIG. 3 is a diagram for describing an example of an emotion distribution;

FIG. 4 is a flowchart describing an example operation of the audio processing device according to an embodiment;

FIG. 5 is a block diagram describing an example application of the audio processing device according to an embodiment; and

FIG. 6 is a diagram illustrating example locations of a display device, a vehicle interior camera, and a microphone in the interior of a vehicle to which a dialogue device is provided.

### DETAILED DESCRIPTION OF THE INVENTION

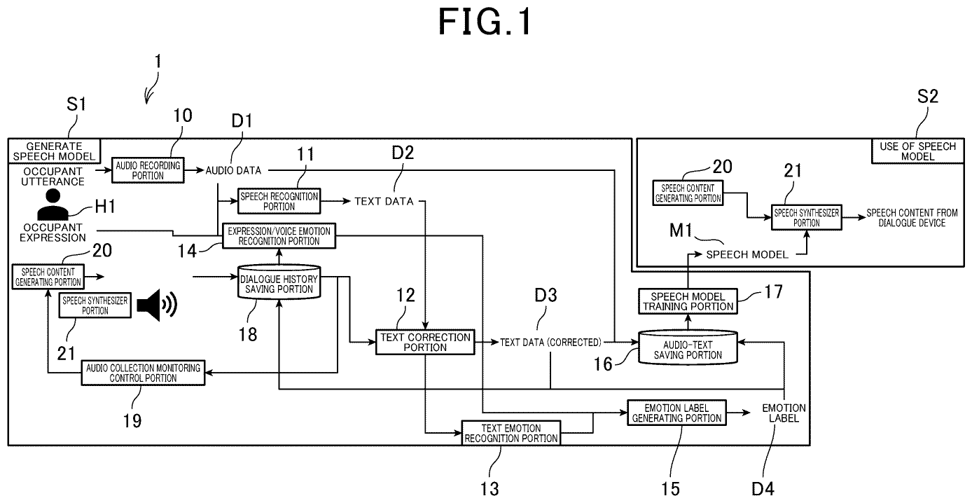

The audio processing device according to the present embodiment is described below with reference to the drawings. FIG. 1 is a block diagram describing an example configuration of the audio processing device according to the embodiment.

As shown in FIG. 1, an audio processing device 1 includes, as constituent elements of a functional configuration related to generation of a speech model (S1), an audio recording portion 10, a speech recognition portion 11, a text correction portion 12, a text emotion recognition portion 13, an expression/voice emotion recognition portion 14, an emotion label generating portion 15, an audio-text saving portion 16, a speech model training portion 17, a dialogue history saving portion 18, an audio collection monitoring control portion 19, a speech content generating portion 20, and a speech synthesizer portion 21. The audio processing device 1 also includes, as constituent elements of a functional configuration related to use of speech model (S2) that uses a speech model M1 generated, the speech content generating portion 20 and the speech synthesizer portion 21.

The audio processing device 1 is an information processing device in which a computer, such as a processor, executes a program to implement the functional configurations described above. As the audio processing device 1, for example, a smartphone, a PC (personal computer), an in-vehicle system to be provided to a vehicle, and the like can be applied. Note that, in the present embodiment, an example is described in which an in-vehicle system is applied as the audio processing device 1. In this example, a user of the audio processing device 1 is an occupant H1 in a vehicle to which the in-vehicle system is provided.

The audio recording portion 10 is a processing portion that records an utterance made by the occupant H1 and outputs audio data D1 that has been recorded. Specifically, the audio recording portion 10 records the audio data D1 including the utterance made by the occupant H1 in reply to speech content audibly output by the speech synthesizer portion 21 to the occupant H1.

The speech recognition portion 11 is a processing portion that recognizes the utterance by the occupant H1 on the basis of the recorded audio data D1 by using a publicly known speech recognition technology, converts the recognized speech to text, and outputs resulting text data D2. Specifically, the speech recognition portion 11 outputs the text data D2, which results from text conversion performed on the utterance made by the occupant H1 in reply to the speech content audibly output by the speech synthesizer portion 21 to the occupant H1.

The text correction portion 12 is a processing portion that corrects the text data D2, resulting from the text conversion by the speech recognition portion 11, on the basis of a history of dialogue with the occupant H1, and outputs resulting text data (corrected) D3. Specifically, the text correction portion 12 compares the history of dialogue with the occupant H1 saved in the dialogue history saving portion 18, to the text data D2, resulting from the text conversion by the speech recognition portion 11, and corrects an error included in the text data D2 by using a publicly known text editing technology.

The text correction portion 12 compares, for example, a predetermined phoneme in an occurrence portion of the dialogue history to a phoneme in a corresponding portion of the text data D2. If the phonemes are different from each other, as in “Mr. Katou” and “Mr. Satou,” for example, the text correction portion 12 determines that there is an error in the text data D2. The text correction portion 12 then corrects the error determined in the text data D2 so that the text is in accordance with the content of the dialogue history. Specifically, the text correction portion 12 corrects an error in the text data D2 so that the phoneme in question agrees with that in the history of dialogue with the occupant H1 (“Mr. Satou” is corrected to “Mr. Katou,” for example).

The text correction portion 12 may also compare a context in the history of dialogue with the occupant H1 to a context in the text data D2. If the contexts differ from each other, the text correction portion 12 may correct an error in the text data D2 so that its context agrees with that of the dialogue history. For example, if the text data D2 shows “rise” where it should be “raise” based on the context of the dialogue history, the text correction portion 12 may correct the error “rise” to “raise” in the text data D2 so that its context agrees with that of the dialogue history.

The text emotion recognition portion 13 is a processing portion that recognizes the emotions of the occupant H1 on the basis of the text data D2 resulting from the text conversion and correction performed on the utterance made by the occupant H1 in reply to the speech content output by the speech synthesizer portion 21, by using a publicly known emotion recognition technology. Specifically, the text emotion recognition portion 13 extracts, from the text data D2, a word included in the utterance by the occupant H1. The text emotion recognition portion 13 then recognizes the emotion of the occupant H1 on the basis of a dictionary data or the like showing association between user words and user emotions. Alternatively, the text emotion recognition portion 13 may recognize the emotions of the occupant H1 on the basis of the text data D2 by using a publicly known machine learning model trained to output an emotion of a user (the occupant H1) from a text input.

In the present embodiment, the emotions of the user (the occupant H1) are described using a Russell's circumplex model. In this model, the emotions of the user are assessed in degrees on pleasantness-unpleasantness and activation-deactivation in a two-dimensional plane, where all the emotions of the user are arranged in a circle.

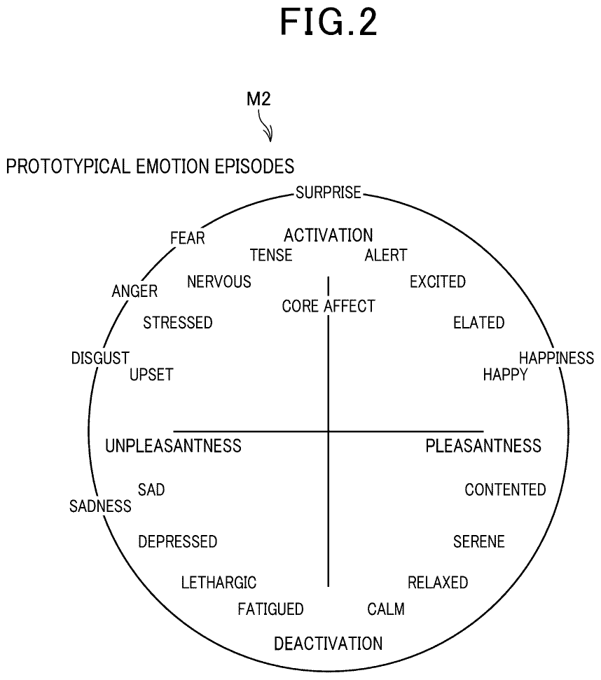

FIG. 2 is a diagram for describing an example of Russell's circumplex model of affect. As shown in FIG. 2, a Russell's circumplex model of affect M2 assesses the degrees of a user's pleasantness-unpleasantness and activation-deactivation in a two-dimensional plane. This model maps, in a circle, user emotions, such as “tense,” “nervous,” “stressed,” “upset,” “sad,” “depressed,” “lethargic,” “fatigued,” “calm,” “relaxed,” “serene,” “contented,” “happy,” “elated,” “excited,” and “alert,” and prototypical emotion episodes, such as fear, anger, disgust, sadness, and happiness.

In the Russell's circumplex model of affect M2, for example, an emotion of the occupant H1 having a high degree on pleasantness-unpleasantness and placed slightly toward activation on activation-deactivation is “happy”, and an emotion of the occupant H1 placed slightly toward deactivation is “contented.”

In addition, the dictionary data or the like showing the association between user words and user emotions corresponds to the Russell's circumplex model of affect M2 described above. For example, in the dictionary data showing the association between user words and user emotions, user words are associated with two-dimensional positions on pleasantness-unpleasantness and activation-deactivation in the Russell's circumplex model of affect M2. Alternatively, user words are associated with emotion labels of “tense,” “nervous,” “stressed,” and so on.

Note that the technique used for the assessment of the emotions of the occupant H1 is not limited to those using the Russell's circumplex model of affect M2 described above. For example, the emotion of the occupant H1 may be assessed using a three-dimensional technique that uses dominance-submissiveness in addition to pleasantness-unpleasantness and activation-deactivation. In another embodiment, other emotion models, such as Millenson's three-dimensional model of emotions may be used. Alternatively, a discrete assessment technique using “joy,” “sad,” “anger,” and the like may be used.

With reference to FIG. 1, the expression/voice emotion recognition portion 14 is a processing portion that recognizes an emotion of the occupant H1 on the basis of the audio data D1 and an expression of the occupant H1 captured by a vehicle interior camera, by using a publicly known emotion recognition technology. Specifically, the expression/voice emotion recognition portion 14 recognizes an emotion of the occupant H1 by inputting, into an emotion estimation model, data including the audio data D1 and the expression of the occupant H1 combined together. The emotion estimation model is built to estimate an emotional value described above (pleasantness-unpleasantness, activation-deactivation, dominance-submissiveness, and the like) from an expression, voice, and an autonomic nervous system response that are measured from a human talker.

The emotion label generating portion 15 is a processing portion that generates an emotion label D4 showing an emotion of the occupant H1 associated with the utterance made by the occupant H1 in reply to the speech content, where the emotion label D4 is generated based on a result of recognition by the text emotion recognition portion 13 and/or a result of recognition by the expression/voice emotion recognition portion 14. Specifically, the emotion label generating portion 15 generates the emotion label D4 showing an emotion corresponding to the position on the Russell's circumplex model of affect M2 on the basis of at least one of the result of recognition by the text emotion recognition portion 13 and the result of recognition by the expression/voice emotion recognition portion 14. The emotion label generating portion 15 is an example of an emotion recognition portion that recognizes, based on at least the audio data D1 that has been recorded, an emotion of the user associated with the utterance by the user.

For example, the emotion label generating portion 15 may generate the emotion label D4 from one of a result of recognition by the text emotion recognition portion 13 and a result of recognition by the expression/voice emotion recognition portion 14. Alternatively, the emotion label generating portion 15 may generate the emotion label D4 by combining the result of recognition by the text emotion recognition portion 13 and the result of recognition by the expression/voice emotion recognition portion 14 (by, for example, averaging the results using a predefined ratio).

The audio-text saving portion 16 saves a piece of the text data (corrected) D3 and the emotion label D4 generated by the emotion label generating portion 15, where the piece of the text data (corrected) D3 and the emotion label D4 are saved in correspondence with a corresponding piece of the audio data D1. That is, the audio-text saving portion 16 is an example of a saving portion.

The speech model training portion 17 is a processing portion that generates the speech model M1 for outputting speech associated with an emotion of the occupant H1, on the basis of the text data (corrected) D3 and the emotion label D4 saved in correspondence with the audio data D1. Specifically, the speech model M1 is a publicly known speech generation AI model capable of generating natural speech that expresses emotions like a human talker does. The speech model training portion 17 generates the speech model M1 by training a publicly known speech generation AI model using, as samples (training data), the text data (corrected) D3 and the emotion label D4 saved in correspondence with the audio data D1. That is, the speech model training portion 17 is an example of a speech model generating portion. The speech model training portion 17 may perform pre-processing as required, such as extracting acoustic features and prosodic information from the audio data D1 and giving human talker information and context information to the text data (corrected) D3.

The dialogue history saving portion 18 saves a history of dialogue with the occupant H1. Specifically, the dialogue history saving portion 18 saves a piece of the text data (corrected) D3 showing the utterance made by the occupant H1 in reply to the speech content generated by the speech content generating portion 20, and the emotion label D4 showing an associated emotion of the occupant H1, where the piece of the text data (corrected) D3 and the emotion label D4 are saved corresponding to the speech content. That is, the dialogue history saving portion 18 saves, as a dialogue history, content of the utterance (the piece of the text data (corrected) D3 and the emotion label D4) corresponding to the speech content addressed to the occupant H1, where the content of the utterance has been made by the occupant H1 in reply to the speech content and saved in the audio-text saving portion 16.

The audio collection monitoring control portion 19 is a processing portion that monitors the audio data D1 and the emotions of the occupant H1, where the audio data D1 is saved corresponding to emotions of the occupant H1 in the audio-text saving portion 16, and that determines whether the number of recorded pieces of the audio data D1 is sufficient to generate the speech model M1 that outputs speech associated with a predefined emotion.

Specifically, the audio collection monitoring control portion 19 monitors the audio data D1 and emotions of the occupant H1 on the basis of the dialogue history saved in the dialogue history saving portion 18, where the audio data D1 is saved corresponding to the emotions of the occupant H1 in the audio-text saving portion 16. Here, the audio collection monitoring control portion 19 determines whether the audio data D1 and the emotions of the occupant H1, as defined in the Russell's circumplex model of affect M2 (“tense,” “nervous,” “stressed,” and so on), are biased. For example, if there is an emotion, out of the emotions defined in the Russell's circumplex model of affect M2, that has a smaller number of recorded pieces of the audio data D1 than the other emotions do, the audio collection monitoring control portion 19 determines that the audio data D1 and the emotions of the occupant H1 are biased, where the audio data D1 is saved corresponding to emotions of the occupant H1 in the audio-text saving portion 16.

If the audio data D1 and the emotions of the occupant H1 are biased as described above, where the audio data D1 is saved corresponding to the emotions of the occupant H1 in the audio-text saving portion 16, the speech model M1, which has been generated based on the data in the audio-text saving portion 16, may not be able to consistently output speech associated with an emotion for which the number of recorded pieces of the audio data D1 is insufficient. Thus, the audio collection monitoring control portion 19 determines that, for an emotion for which the number of recorded pieces of the audio data D1 is insufficient due to a bias in the audio data D1 and the emotions of the occupant H1, where the audio data D1 is saved corresponding to emotions of the occupant H1 in the audio-text saving portion 16, the number of recorded pieces of the audio data D1 is insufficient to generate the speech model M1.

Alternatively, the audio collection monitoring control portion 19 may have a vocabulary and emotions set in advance and may determine whether the vocabulary and emotions have been collected in the audio-text saving portion 16. Specifically, the audio collection monitoring control portion 19 may determine whether the number of recorded pieces of the audio data D1 associated with each of predefined multiple kinds of emotions is equal to or greater than a specific number, and based on that, determine whether the number of recorded pieces of the audio data D1 for each emotion is sufficient. Alternatively, the audio collection monitoring control portion 19 may determine whether the density of an emotion distribution at a specific position in the Russell's circumplex model of affect M2 is at a given level or greater.

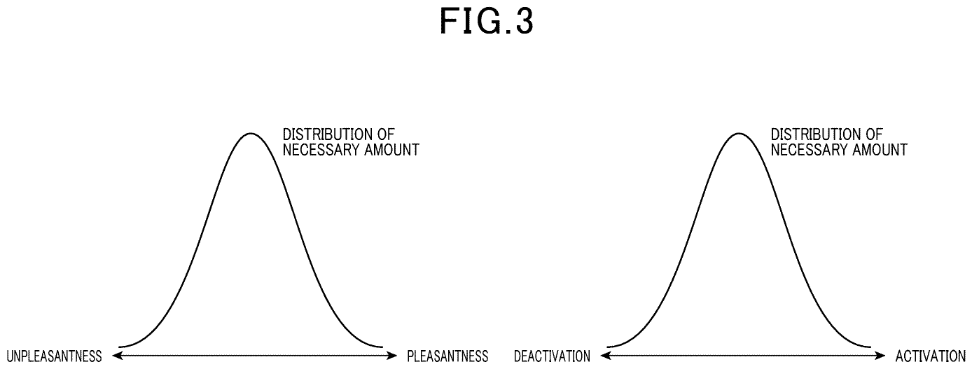

FIG. 3 is a diagram for describing an example of an emotion distribution. The audio collection monitoring control portion 19 uses, for example, a normal distribution as shown in FIG. 3 as a threshold for determining whether the density of an emotion distribution at a specific position in the Russell's circumplex model of affect M2 is at a given level or greater. Using this, the audio collection monitoring control portion 19 can perform the monitoring to increase the number of recorded pieces of the audio data D1 for use in the generation of the speech model M1 as the position shifts closer to the center of the emotion distribution. The audio collection monitoring control portion 19 can also perform the monitoring to decrease the number of recorded pieces of the audio data D1 for use in the generation of the speech model M1 for positions in outer regions of the emotion distribution.

The speech content generating portion 20 is a processing portion that generates speech content to be addressed to the occupant H1. Specifically, the speech content generating portion 20 generates speech content to be addressed to the occupant H1 by using a publicly known dialogue technology using an LLM (large language model) or the like. For example, the speech content generating portion 20 generates speech content to be addressed to the occupant H1 through a server device that generates speech content using an LLM in response to a prompt providing an instruction for generating the speech.

Here, the term “prompt” refers to input information including an instruction, a condition, and reference information that are for an LLM to generate speech content. For example, the term “instruction” includes an instruction for generating speech content, and an original speech content cited in the reference information. The term “condition” includes various conditions related to the speech content to be output. The term “reference information” includes original speech content for speech content to be generated, and a topic to be used for generating the speech content.

The speech content generating portion 20 generates a prompt for generating speech content associated with a predefined emotion and notifies the server device, which generates speech content using an LLM, about the generated prompt. This allows the speech content generating portion 20 to generate speech content associated with the predefined emotion. Specifically, the speech content generating portion 20 generates speech content associated with an emotion for which the number of recorded pieces of the audio data D1 is insufficient, on the basis of a result of monitoring by the audio collection monitoring control portion 19.

Assuming that the number of recorded pieces of the audio data D1 for, for example, the emotion of anger is insufficient. The occupant H1's emotion recognized by the emotion label generating portion 15 may be anger toward a surrounding traffic situation, such as a vehicle cut-in ahead. If so, the speech content generating portion 20 generates speech content designed to alleviate the anger. By starting a conversation designed to alleviate the anger using the generated speech content, the audio processing device 1 can record a piece of the audio data D1 from the occupant H1 for the emotion of anger, for which the number of recorded pieces is insufficient.

Assuming that the number of recorded pieces of the audio data D1 for an emotion related to deactivation (for example, fatigued, lethargic, or the like) is insufficient. In this case, the speech content generating portion 20 generates speech content in a period of time in which the circadian rhythm (biological clock) is expected to induce drowsiness, such as early afternoon. This allows the audio processing device 1 to record a piece of the audio data D1 from the occupant H1 for an emotion related to the deactivation, for which the number of recorded pieces is insufficient.

The speech content generating portion 20 may also generate speech content designed to elicit from the occupant H1 an emotion for which the number of recorded pieces is insufficient. For example, the speech content generating portion 20 may generate speech content about a topic that suits the occupant H1's liking based on a dialogue history saved in the dialogue history saving portion 18. This allows the audio processing device 1 to record a piece of audio data D1 for an emotion of the occupant H1 on pleasantness (for example, happy, contented). On the other hand, the speech content generating portion 20 may also generate speech content about a topic that does not suit the occupant H1's liking at all. This allows the audio processing device 1 to record a piece of audio data D1 for an emotion of the occupant H1 on unpleasantness (for example, upset, sad). Alternatively, the audio processing device 1 may generate speech content expressing a specific emotion to thereby elicit the same emotion from the user through emotion transfer.

The speech synthesizer portion 21 performs speech synthesis on the speech content generated by the speech content generating portion 20 and outputs a result to the occupant H1 via a speaker or the like. When performing the speech synthesis, the speech synthesizer portion 21 may use the speech model M1 generated by the speech model training portion 17, as shown in the “Use of speech model” (S2) in FIG. 1. This allows the speech synthesizer portion 21 to output more realistic speech based on the generated speech model M1.

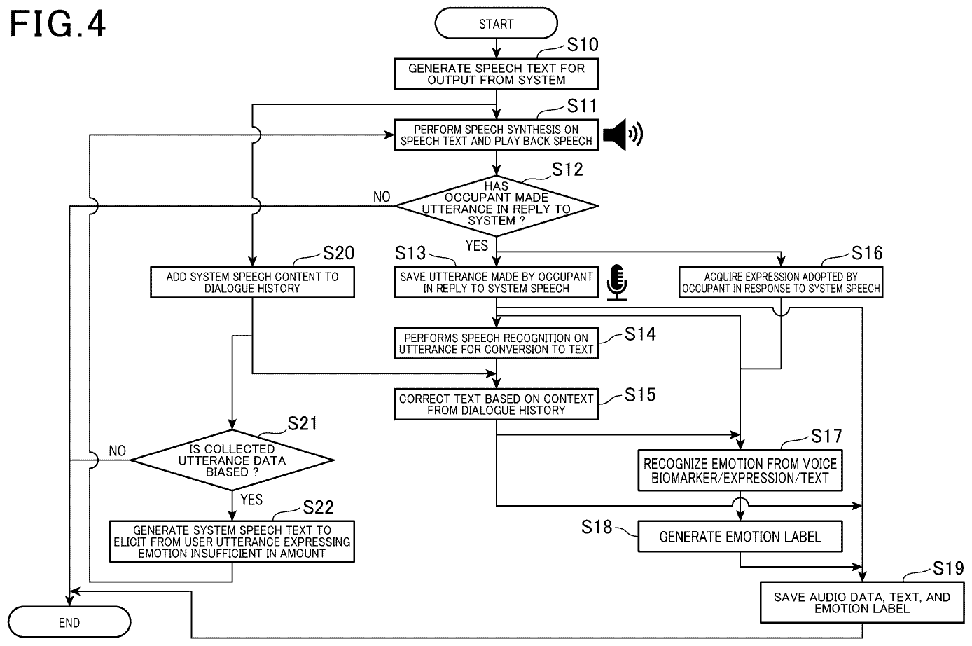

FIG. 4 is a flowchart describing an example operation of the audio processing device 1 according to an embodiment. As shown in FIG. 4, the processing is started, and then, in S10, the speech content generating portion 20 generates a speech text (speech content) to be output from the in-vehicle system to the occupant H1.

Subsequently, in S11, the speech synthesizer portion 21 performs speech synthesis on the speech text and plays back the speech content to the occupant H1. Then, in S12, the audio recording portion 10 determines whether the occupant H1 has made an utterance in reply to the in-vehicle system.

Specifically, the audio recording portion 10 determines whether the voice of the occupant H1 is included in each short time window of audio signals by using voice activity detection and determines whether the occupant H1 has made a reply utterance on the basis of a period of time during which a silence interval continues. If there is no utterance made by the occupant H1 (S12: No), the audio processing device 1 ends the processing.

If there is an utterance by the occupant H1 (S12: Yes), the processing proceeds to S13 in which the audio recording portion 10 acquires audio data of the utterance made by the occupant H1 in reply to the in-vehicle system and saves the utterance by the occupant H1 as a piece of the audio data D1. The piece of the audio data D1 thus saved may be, for example, a wav file.

Then, in S14, the speech recognition portion 11 performs speech recognition on the utterance by the occupant H1 on the basis of the piece of the audio data D1 and converts a result to the text data D2. Then, in S15, the text correction portion 12 corrects the text data D2 on the basis of the context obtained from a history of dialogue with the occupant H1.

If there is an utterance by the occupant H1 (S12: Yes), the processing also proceeds to S16 in which the expression/voice emotion recognition portion 14 acquires an expression adopted by the occupant H1 when the occupant H1 has made the utterance to the in-vehicle system.

Then, in S17, the expression/voice emotion recognition portion 14 and the text emotion recognition portion 13 recognize the emotion of the occupant H1 from a voice biomarker/an expression/text content included in the piece of the audio data D1 by using a publicly known emotion recognition technology.

Subsequently, in S18, by using a result of recognition in S17 as a basis, the emotion label generating portion 15 generates the emotion label D4 showing the occupant H1's emotion associated with the utterance made by the occupant H1.

Subsequently, in S19, the audio-text saving portion 16 saves a piece of the text data (corrected) D3 and the emotion label D4, which has been generated by the emotion label generating portion 15, in correspondence with the piece of the audio data D1.

In addition, in S20, the dialogue history saving portion 18 adds, to the dialogue history, the piece of the text data (corrected) D3 and the emotion label D4 in correspondence with the speech content generated by the speech content generating portion 20, where the piece of the text data (corrected) D3 shows the utterance made by the occupant H1 in reply to the speech content, and the emotion label D4 shows the associated emotion of the occupant H1.

Then, in S21, the audio collection monitoring control portion 19 determines whether emotions corresponding to pieces of the audio data D1 that have been recorded are biased on the basis of the dialogue history saved in the dialogue history saving portion 18. If there is no bias (S21: No), the audio collection monitoring control portion 19 ends the processing.

If there is a bias (S21: Yes), the processing proceeds to S22 in which the speech content generating portion 20 generates a speech text (speech content) designed to elicit, from the occupant H1 (the user), a (spoken) utterance expressing an emotion for which the number of recorded pieces is insufficient. The processing then returns to S11. This allows the speech synthesizer portion 21 to output speech content designed to elicit, from the occupant H1, a (spoken) utterance expressing an emotion for which the number of recorded pieces is insufficient.

As described above, the audio processing device 1 includes the speech content generating portion 20, the speech synthesizer portion 21, the audio recording portion 10, the emotion label generating portion 15, the audio-text saving portion 16, and the speech model training portion 17. The speech content generating portion 20 generates speech content to be addressed to the occupant H1 (the user). The speech synthesizer portion 21 outputs the generated speech content to the occupant H1. The audio recording portion 10 records a piece of the audio data D1 including an utterance made by the occupant H1 in reply to the speech content. Based on at least the piece of the audio data D1 that has been recorded, the emotion label generating portion 15 recognizes the occupant H1's emotion associated with the utterance made by the occupant H1 in reply to the speech content. The audio-text saving portion 16 saves the piece of the audio data D1 recorded and the emotion of the occupant H1 recognized, with the piece of the audio data D1 corresponding to the emotion. The speech model training portion 17 generates the speech model M1 for outputting speech associated with an emotion of the occupant H1, on the basis of the audio data D1 and emotions of the occupant H1 saved with each piece of the audio data D1 corresponding to one of the emotions.

Thus, the audio processing device 1 is capable of collecting speech in conversational form, instead of making the occupant H1 (the user) read a script, thereby readily acquiring audio data D1 having natural intonation and expressing emotions. The audio processing device 1 uses the audio data D1 to generate the speech model M1 and is thereby capable of also generating the speech model M1 for outputting speech having natural intonation and realistically expressing emotions.

The audio processing device 1 further includes the audio collection monitoring control portion 19 that monitors the audio data D1 and the emotions of the occupant H1, where the audio data D1 and the emotions of the occupant H1 are saved with each piece of the audio data D1 corresponding to one of the emotions, and that determines whether the number of recorded pieces of the audio data D1 is sufficient to generate the speech model M1 that outputs speech associated with a predefined emotion. The speech content generating portion 20 generates speech content associated with an emotion for which the number of recorded pieces of the audio data D1 is insufficient, on the basis of a result of monitoring by the audio collection monitoring control portion 19.

The audio processing device 1 is, thus, capable of generating and conducting a conversation for adding utterance variations associated with an emotion for which the number of recorded pieces of the audio data D1 is insufficient, thereby improving the exhaustiveness of the audio data D1 and enhancing the quality of the speech model M1.

The speech content generating portion 20 also generates speech content that elicits from the occupant H1 an emotion for which the number of recorded pieces of the audio data D1 is insufficient.

Thus, the audio processing device 1 is capable of eliciting from the occupant H1 an emotion for which the number of recorded pieces of the audio data D1 is insufficient, thereby improving the exhaustiveness of the audio data D1 more efficiently.

In addition, the speech synthesizer portion 21 outputs speech conveying the speech content to the occupant H1, where the speech is based on the speech model M1 generated.

The audio processing device 1 is, thus, capable of outputting, to the occupant H1, speech having natural intonation and realistically expressing emotions on the basis of the generated speech model M1.

The emotion label generating portion 15 acquires, through the expression/voice emotion recognition portion 14, an expression adopted by the occupant H1 when the utterance is made by the occupant H1 in reply to the speech content, and recognizes the emotion of the occupant H1 based also on the expression acquired from the occupant H1.

The audio processing device 1 is, thus, capable of recognizing the occupant H1's emotion based also on the expression of the occupant H1, thereby recognizing the emotions of the user further accurately.

The audio processing device 1 also includes the speech recognition portion 11, the dialogue history saving portion 18, and the text correction portion 12. The speech recognition portion 11 converts to text, the utterance made by the occupant H1 in reply to the speech content, on the basis of the piece of the recorded audio data D1. The dialogue history saving portion 18 records, as a dialogue history, the speech content and the utterance made by the occupant H1 and converted to text. The text correction portion 12 corrects the utterance made by the occupant H1 and converted to text, on the basis of the dialogue history.

The audio processing device 1 is, thus, capable of accurately generating a dialogue history including the occupant H1's utterance converted to text.

### Example Application in In-Vehicle System

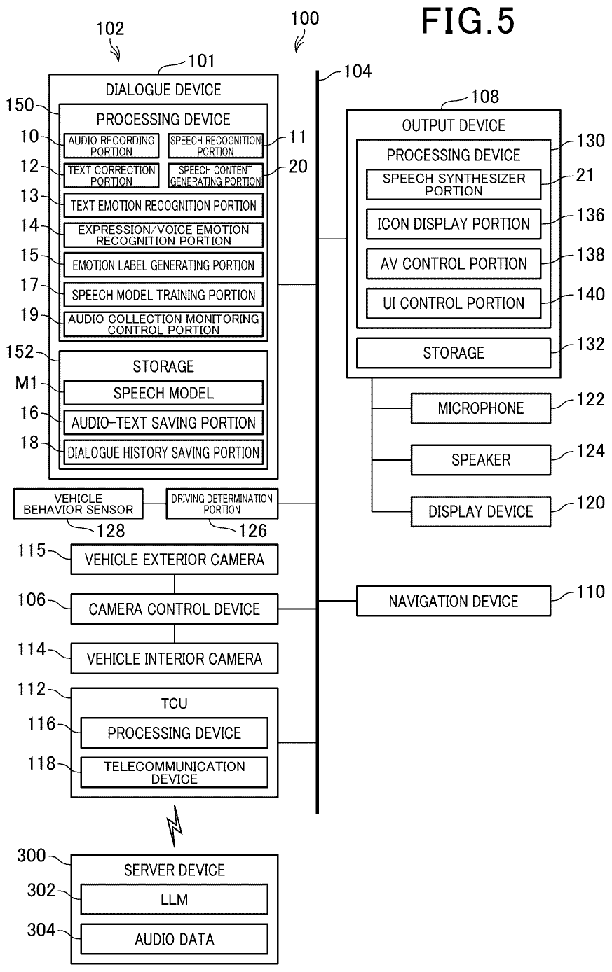

FIG. 5 is a block diagram for describing an example application of the audio processing device 1 according to an embodiment. Specifically, FIG. 5 is a block diagram showing an example configuration in which the audio processing device 1 described above is applied in an in-vehicle system 100 provided to a vehicle 102.

As shown in FIG. 5, the in-vehicle system 100 is provided to, for example, the vehicle 102, which is a mobile body. Hereinafter, a user is an occupant of the vehicle 102, which is a mobile body, and the occupant includes the driver of the vehicle 102.

The in-vehicle system 100 is communicably connected, through an in-vehicle network bus 104, to a camera control device 106 (computer), an output device 108, a navigation device 110 (computer), a TCU (telematics control unit) 112, and a dialogue device 101, for example.

The camera control device 106 controls the operations of a vehicle interior camera 114 and a vehicle exterior camera 115. Specifically, the camera control device 106 captures an image of at least a movement of the user within the interior of the vehicle 102 through the vehicle interior camera 114 and transmits the captured image of the vehicle interior to other devices, such as the dialogue device 101 and the output device 108. The camera control device 106 also captures an image of the surroundings of the vehicle 102 through the vehicle exterior camera 115 and transmits the captured image of the vehicle surroundings to other devices, such as the dialogue device 101 and the output device 108. A driving determination portion 126 (computer) determines a driving manipulation by using data (accelerator, brakes, steering, acceleration/deceleration, yaw, and the like) related to the behavior of the vehicle 102 resulting from a driving manipulation detected by a vehicle behavior sensor 128. For example, the driving determination portion 126 determines the presence of a driving manipulation anomaly such as erratic driving.

The TCU 112 includes a telecommunication device 118 and a processing device 116 that controls the operation of the telecommunication device 118. The processing device 116 is, for example, a computer that includes a processor, such as a CPU (central processing unit). The telecommunication device 118 is, for example, a wireless communication device that communicates with different server devices 300 that provide a conversational service, information such as news, and the like through the internet or other communication networks.

A server device 300 (computer) provides a conversational service where conversational content is generated and output by using an LLM 302 in response to a prompt including speech content or the like. In addition, the server device 300 provides audio data 304 associated with emotions.

Here, the audio data 304 is audio data that has been recorded in advance from an unspecified large number of users and includes many pieces of speech associated with the emotions defined on the Russell's circumplex model of affect M2. The server device 300 provides a piece of the audio data 304 including speech associated with a predefined emotion in response to a request from an external device such as the vehicle 102.

The output device 108 is connected to a display device 120, a microphone 122, and a speaker 124 and outputs audio and video for the occupant (the user) of the vehicle 102. For example, the output device 108 outputs speech content, provided by the dialogue device 101, through the speaker 124 as audio by using a speech synthesis function and collects an utterance by the user through the microphone 122. The output device 108 outputs audio data collected through the microphone 122 to the dialogue device 101.

The output device 108 plays a tune of music, video, or the like and outputs the audio in response to an instruction input from the user through an input device such as a touch panel included in the display device 120, and/or a verbal instruction in a spoken conversation with the user. In response to an instruction input from the user through the input device or a verbal instruction from the user, the output device 108 searches, for example, servers on the internet and the like through the TCU 112 and acquires information the user is looking for. The output device 108 then outputs image information and audio information, thus acquired, to the display device 120 and the speaker 124. Alternatively, the output device 108 converts text information, thus acquired, to audio through the speech synthesis function and outputs a result to the speaker 124.

Specifically, the output device 108 includes a processing device 130 and a storage 132. The storage 132 is configured using, for example, a volatile and/or nonvolatile semiconductor memory, a hard disk drive, and/or a reading device for a removable storage medium, such as a CD (compact disc), a DVD (digital versatile disc), and a USB (universal serial bus) memory, or the like.

The processing device 130 is a computer that includes a processor, such as a CPU (central processing unit). The processing device 130 includes the speech synthesizer portion 21 described above, as well as an icon display portion 136, an AV (audio visual) control portion 138, and a UI (user interface) control portion 140, each being a functional element or a functional unit that is implemented by execution of a program.

The processing device 130, for example, causes the speech synthesizer portion 21 to output speech content provided by the dialogue device 101 as audio. Specifically, the speech synthesizer portion 21 converts speech content (text) into audio through the speech synthesis function for output from the speaker 124. The processing device 130 also outputs, to the dialogue device 101, audio data of an utterance made by the user and recorded through the microphone 122.

The processing device 130 also conducts a spoken conversation with the user through the UI control portion 140, which is to be described below. For example, the processing device 130 determines whether the user has said a specific phrase (known as a wakeup word or a trigger word) that indicates the start of a verbal instruction. Upon determining that the user has said a wakeup word, the processing device 130 recognizes the user's following utterance as a verbal instruction. Then, in response to the recognized verbal instruction, the processing device 130 plays back a tune and video stored in the storage 132 or the like, plays content found in a server on the internet or the like, and/or outputs text information found in a server on the internet or the like as audio. Note that, instead of using a wakeup word, the processing device 130 may use the voice activity detection to detect a speech interval and perform speech recognition on an utterance within the interval.

The icon display portion 136 displays a human figure icon in a portion of a screen of the display device 120 when at least audio is being output from the speaker 124. Here, the human figure icon may be an icon that looks like a person or an image of a person. In addition, an image used for the human figure icon may be a photograph of a person or an image artificially generated using computer graphics or the like.

The AV control portion 138 plays back AV content, such as a tune, video, and image, for output to the speaker 124 and/or the display device 120, following a conventional technology. The AV content includes, for example, content stored in a medium, such as a DVD, read by the reading device included in the storage 132, as well as content downloaded from a server on the internet or the like by the processing device 130 through the TCU 112 and stored in the storage 132 in response to a verbal instruction from the user. The AV control portion 138 also outputs, to the speaker 124, audio from a radio program and a TV program received by a receiver (not shown) for receiving radio waves for radio and TV broadcasting. The AV control portion 138 may also output video from a TV program to the display device 120 when appropriate.

The UI control portion 140 controls the operations of UI devices including the display device 120, the microphone 122, and the speaker 124. For example, the UI control portion 140 controls the output of audio information through the speaker 124 in response to an instruction from the dialogue device 101. Also, in response to an instruction from the dialogue device 101 to turn off audio, the UI control portion 140 stops outputting audio information through the speaker 124 and instructs the processing device 130, the AV control portion 138, and/or the navigation device 110 to end operations involving the output of audio.

In addition, in response to an instruction from the AV control portion 138, the navigation device 110, and/or the dialogue device 101, the UI control portion 140 displays an image or video specified in the instruction on the display device 120. The UI control portion 140 also transmits an input from the user via the touch panel (not shown), included in the display device 120, to the AV control portion 138, the navigation device 110, and/or the dialogue device 101.

In addition, in response to an instruction from the AV control portion 138, the navigation device 110, and/or the dialogue device 101, the UI control portion 140 outputs to the speaker 124 an audio message specified in the instruction. The UI control portion 140 may also acquire an utterance by the user, such as a verbal instruction, through the microphone 122 and transmit a result of speech recognition on the utterance to the AV control portion 138, the navigation device 110, and/or the dialogue device 101.

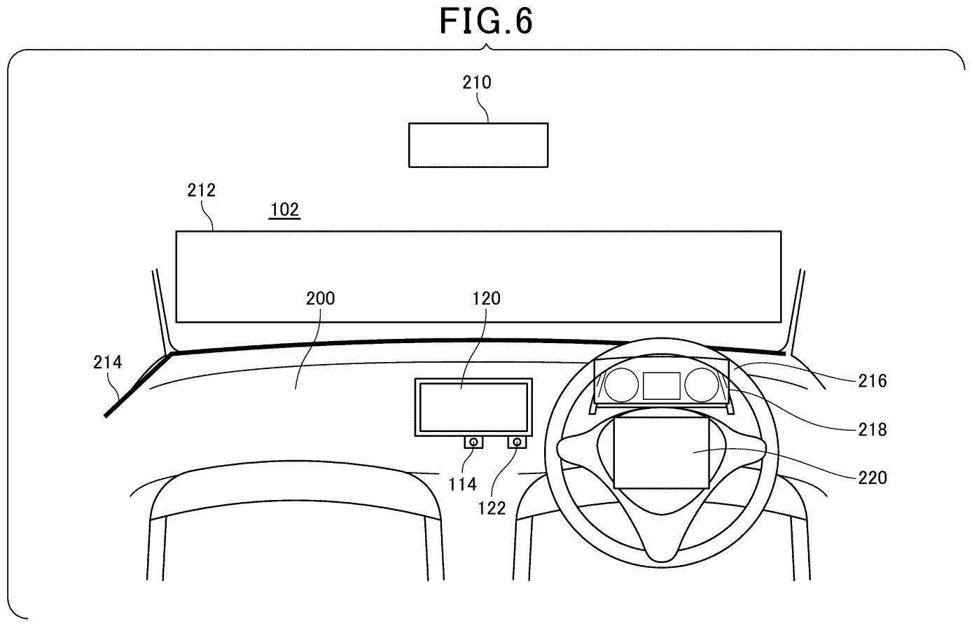

FIG. 6 is a diagram illustrating example locations of the display device 120, the vehicle interior camera 114, and the microphone 122 in the interior of the vehicle 102 to which the dialogue device 101 is provided. As shown in FIG. 6, the display device 120 is located, for example, in a vehicle-width-direction middle portion of an instrument panel 200 of the vehicle 102. The microphone 122 is located at a lower portion of the display device 120 toward the driver. The vehicle interior camera 114 is at a location that allows the vehicle interior camera 114 to capture an image of the face of a user (the driver or an occupant in the front passenger seat). In the example shown in FIG. 4, the vehicle interior camera 114 is at a lower middle portion of the display device 120. Note that the functions and location of the display device 120 are not limited to the examples described above. For example, the display device 120 may provide a visual representation on a rearview mirror 210, a head-up display on a windshield 212, an AR (augmented reality) display, and the like. The display device 120 may also provide other types of display, such as providing strip lighting 214 near the instrument panel 200 and the windshield 212, and providing a visual representation on a steering wheel upper portion 216, instrumentation 218, and a steering display 220. In addition, the display device 120 may be a dedicated tangible display portion or a character.

The dialogue device 101 includes a processing device 150 and a storage 152. The storage 152 is configured using, for example, a volatile and/or nonvolatile semiconductor memory, and/or a hard disk drive, and the like. The storage 152 includes the speech model M1, the audio-text saving portion 16, and the dialogue history saving portion 18.

The processing device 150 is a computer that includes a processor, such as a CPU. The processing device 150 may be configured using a ROM (read-only memory) in which a program has been written, a RAM (random access memory) for temporarily storing data, and the like. The processing device 150 implements each of the constituent elements of the functional configuration of the audio processing device 1 described above by executing a program. Specifically, the processing device 150 functions as the audio recording portion 10, the speech recognition portion 11, the text correction portion 12, the text emotion recognition portion 13, the expression/voice emotion recognition portion 14, the emotion label generating portion 15, the speech model training portion 17, the audio collection monitoring control portion 19, and the speech content generating portion 20.

Therefore, the in-vehicle system 100 is capable of readily outputting realistic speech to the occupant H1 in the vehicle 102.

In addition, the audio recording portion 10 may acquire a piece of the audio data D1 associated with an emotion for which the number of recorded pieces is insufficient, from the server device 300, which provides the audio data 304 associated with emotions.

Therefore, the in-vehicle system 100 is capable of efficiently acquiring, through the server device 300, a piece of the audio data 304 associated with an emotion for which the number of recorded pieces is insufficient.

The foregoing embodiments are provided merely to illustrate the technology in the present disclosure. Thus, various modifications, permutations, additions, omissions, and the like are possible within the scope of the appended claims or their equivalents.

For example, the configuration of the constituent elements of the in-vehicle system 100 shown in FIG. 5 merely provides an example, and a specific implementation is not particularly limited. That is, a piece of hardware does not need to be implemented to individually correspond to each constituent element, and it is of course possible to implement the functions of every constituent element by one processor executing a program. In addition, some of the functions implemented by software in the embodiments described above may be implemented by hardware, or some of the functions implemented by hardware in the embodiments described above may be implemented by software.

In addition, the operation of the audio processing device 1 shown in FIG. 4 has been divided into step units in accordance with main processing; the way processing units have been divided or their names do not limit the present disclosure. The operation may be divided into more step units in accordance with the processing. The operation may be divided such that one step unit includes more processing. The order of the steps may be changed as appropriate as long as no impediment is presented to the spirit of the present disclosure.

In addition, when the audio processing method using a computer, such as the processing device 150 of the dialogue device 101 described above, is implemented using a processor, a program executed by the processor can be implemented in the form of a recording medium or a transmission medium for transmitting the program. That is, the program described above can be provided as recorded on a portable information recording medium. Examples of the information recording medium include magnetic recording media such as a hard disk, optical recording media such as a CD, and semiconductor storage devices such as a USB (universal serial bus) memory and an SSD (solid state drive), but other recording media can be also used.

### Configurations Supported by the Foregoing Embodiments

The foregoing embodiments support the following configurations.

### (First Configuration)

An audio processing device including: a speech content generating portion configured to generate speech content to be addressed to a user; a speech output portion configured to output to the user the speech content generated; an audio recording portion configured to record a piece of audio data, the piece of the audio data including an utterance made by the user in reply to the speech content; an emotion recognition portion configured to recognize an emotion of the user on a basis of at least the piece of the audio data recorded, the emotion of the user being associated with the utterance made by the user in reply to the speech content; a saving portion configured to save the piece of the audio data recorded and the emotion of the user recognized, the piece of the audio data being saved corresponding to the emotion of the user; and a speech model generating portion configured to generate a speech model for outputting speech associated with an emotion of the user, on the basis of the audio data and emotions of the user saved with each piece of the audio data corresponding to one of the emotions.

The audio processing device having the first configuration is capable of generating a speech model by using an utterance made by a user in reply to speech content generated and thereby readily generating a speech model that outputs realistic speech.

### (Second Configuration)

The audio processing device according to the first configuration, further including a monitoring portion configured to monitor the audio data and the emotions of the user saved with each piece of the audio data corresponding to one of the emotions and to determine whether the number of recorded pieces of the audio data is sufficient to generate the speech model that outputs speech associated with a predefined emotion, wherein the speech content generating portion generates the speech content that is associated with an emotion, the number of recorded pieces of the audio data being insufficient for the emotion.

The audio processing device having the second configuration is capable of generating speech content associated with an emotion for which the number of recorded pieces of the audio data is insufficient and thereby efficiently recording the audio data associated with the emotion.

### (Third Configuration)

The audio processing device according to the second configuration, wherein the speech content generating portion generates the speech content that elicits the emotion from the user, the number of recorded pieces of the audio data being insufficient for the emotion.

The audio processing device having the third configuration is capable of eliciting from the user an emotion for which the number of recorded pieces of the audio data is insufficient and thereby efficiently recording the audio data associated with the emotion.

### (Fourth Configuration)

The audio processing device according to any one of the first to third configurations, further including a monitoring portion configured to monitor the audio data and the emotions of the user saved with each piece of the audio data corresponding to one of the emotions and to determine whether the number of recorded pieces of the audio data is sufficient to generate the speech model that outputs speech associated with a predefined emotion, wherein the audio recording portion acquires a piece of the audio data from a server device that provides audio data associated with emotions, the piece of the audio data being associated with an emotion, the number of recorded pieces of the audio data being insufficient for the emotion.

The audio processing device having the fourth configuration is capable of efficiently acquiring, through the server device, a piece of the audio data associated with an emotion for which the number of recorded pieces is insufficient.

### (Fifth Configuration)

The audio processing device according to any one of the first to fourth configurations, wherein the speech output portion outputs speech conveying the speech content to the user, the speech being based on the speech model.

The audio processing device having the fifth configuration is capable of outputting, to the user, speech conveying the speech content based on the generated speech model.

### (Sixth Configuration)

The audio processing device according to any one of the first to fifth configurations, wherein the emotion recognition portion acquires an expression adopted by the user when the utterance is made by the user in reply to the speech content, and recognizes an emotion of the user based also on the expression acquired from the user.

The audio processing device having the sixth configuration is capable of recognizing an emotion of the user more accurately on the basis of an expression adopted by the user.

### (Seventh Configuration)

The audio processing device according to any one of the first to sixth configurations, further including: a text conversion portion configured to convert to text, the utterance made by the user in reply to the speech content, on the basis of the piece of the audio data recorded; a dialogue history saving portion configured to save, as a dialogue history, the speech content and the utterance made by the user and converted to text; and a text correction portion configured to correct the utterance made by the user and converted to text, on the basis of the dialogue history.

The audio processing device having the seventh configuration is capable of generating an accurate dialogue history including the user's utterance converted to text.

### (Eighth Configuration)

An audio processing method including a computer executing processing of: generating speech content to be addressed to a user; outputting to the user the speech content generated; recording a piece of audio data, the piece of the audio data including an utterance made by the user in reply to the speech content; recognizing an emotion of the user on a basis of at least the piece of the audio data recorded, the emotion of the user being associated with the utterance made by the user in reply to the speech content; saving the piece of the audio data recorded and the emotion of the user recognized, the piece of the audio data being saved corresponding to the emotion of the user; and generating a speech model for outputting speech associated with an emotion of the user, on the basis of the audio data and emotions of the user saved with each piece of the audio data corresponding to one of the emotions.

The audio processing method according to the eighth configuration has effectiveness equivalent to that of the first configuration.

### (Ninth Configuration)

An in-vehicle system to be provided to a vehicle, the in-vehicle system including: a speech content generating portion configured to generate speech content to be addressed to an occupant in the vehicle; a speech output portion configured to output to the occupant the speech content generated; an audio recording portion configured to record a piece of audio data, the piece of the audio data including an utterance made by the occupant in reply to the speech content; an emotion recognition portion configured to recognize an emotion of the occupant on a basis of at least the piece of the audio data recorded, the emotion of the occupant being associated with the utterance made by the occupant in reply to the speech content; a saving portion configured to save the piece of the audio data recorded and the emotion of the occupant recognized, the piece of the audio data being saved corresponding to the emotion of the occupant; and a speech model generating portion configured to generate a speech model for outputting speech associated with an emotion of the occupant, on the basis of the audio data and emotions of the occupant saved with each piece of the audio data corresponding to one of the emotions.

The in-vehicle system having the ninth configuration has effectiveness equivalent to that of the first configuration.

### REFERENCE SIGNS LIST

1 audio processing device
10 audio recording portion
11 speech recognition portion
12 text correction portion
13 text emotion recognition portion
14 expression/voice emotion recognition portion
15 emotion label generating portion
16 audio-text saving portion
17 speech model training portion
18 dialogue history saving portion
19 audio collection monitoring control portion
20 speech content generating portion
21 speech synthesizer portion
100 in-vehicle system
101 dialogue device
102 vehicle
104 in-vehicle network bus p1 106 camera control device
108 output device
110 navigation device
112 TCU
114 vehicle interior camera
115 vehicle exterior camera
116 processing device
118 telecommunication device
120 display device
122 microphone
124 speaker
126 driving determination portion
128 vehicle behavior sensor
130 processing device
132 storage
136 icon display portion
138 AV control portion
140 UI control portion
150 processing device
152 storage
200 instrument panel
210 rearview mirror
212 windshield
214 strip lighting
216 steering wheel upper portion
218 instrumentation
220 steering display
300 server device
302 LLM
304 audio data
D1 audio data
D2 text data
D3 text data (corrected)
D4 emotion label
H1 occupant
M1 speech model
M2 Russell's circumplex model of affect

1. An audio processing device comprising:
a speech content generating portion configured to generate speech content to be addressed to a user;
a speech output portion configured to output to the user the speech content generated;
an audio recording portion configured to record a piece of audio data, the piece of the audio data including an utterance made by the user in reply to the speech content;
an emotion recognition portion configured to recognize an emotion of the user on a basis of at least the piece of the audio data recorded, the emotion of the user being associated with the utterance made by the user in reply to the speech content;
a saving portion configured to save the piece of the audio data recorded and the emotion of the user recognized, the piece of the audio data being saved corresponding to the emotion of the user; and
a speech model generating portion configured to generate a speech model for outputting speech associated with an emotion of the user, on the basis of the audio data and emotions of the user saved with each piece of the audio data corresponding to one of the emotions.

2. The audio processing device according to claim 1, further comprising a monitoring portion configured to monitor the audio data and the emotions of the user saved with each piece of the audio data corresponding to one of the emotions and to determine whether the number of recorded pieces of the audio data is sufficient to generate the speech model that outputs speech associated with a predefined emotion,
wherein the speech content generating portion generates the speech content that is associated with an emotion, the number of recorded pieces of the audio data being insufficient for the emotion.

3. The audio processing device according to claim 2, wherein the speech content generating portion generates the speech content that elicits the emotion from the user, the number of recorded pieces of the audio data being insufficient for the emotion.

4. The audio processing device according to claim 1, further comprising a monitoring portion configured to monitor the audio data and the emotions of the user saved with each piece of the audio data corresponding to one of the emotions and to determine whether the number of recorded pieces of the audio data is sufficient to generate the speech model that outputs speech associated with a predefined emotion,
wherein the audio recording portion acquires a piece of the audio data from a server device that provides audio data associated with emotions, the piece of the audio data being associated with an emotion, the number of recorded pieces of the audio data being insufficient for the emotion.

5. The audio processing device according to claim 1, wherein the speech output portion outputs speech conveying the speech content to the user, the speech being based on the speech model.

6. The audio processing device according to claim 1, wherein the emotion recognition portion acquires an expression adopted by the user when the utterance is made by the user in reply to the speech content, and recognizes an emotion of the user based also on the expression acquired from the user.

7. The audio processing device according to claim 1, further comprising:
a text conversion portion configured to convert to text, the utterance made by the user in reply to the speech content, on the basis of the piece of the audio data recorded;
a dialogue history saving portion configured to save, as a dialogue history, the speech content and the utterance made by the user and converted to text; and
a text correction portion configured to correct the utterance made by the user and converted to text, on the basis of the dialogue history.

8. An audio processing method comprising a computer executing processing of:
generating speech content to be addressed to a user;
outputting to the user the speech content generated;
recording a piece of audio data, the piece of the audio data including an utterance made by the user in reply to the speech content;
recognizing an emotion of the user on a basis of at least the piece of the audio data recorded, the emotion of the user being associated with the utterance made by the user in reply to the speech content;
saving the piece of the audio data recorded and the emotion of the user recognized, the piece of the audio data being saved corresponding to the emotion of the user; and
generating a speech model for outputting speech associated with an emotion of the user, on the basis of the audio data and emotions of the user saved with each piece of the audio data corresponding to one of the emotions.

9. An in-vehicle system to be provided to a vehicle, the in-vehicle system comprising:
a speech content generating portion configured to generate speech content to be addressed to an occupant in the vehicle;
a speech output portion configured to output to the occupant the speech content generated;
an audio recording portion configured to record a piece of audio data, the piece of the audio data including an utterance made by the occupant in reply to the speech content;
an emotion recognition portion configured to recognize an emotion of the occupant on a basis of at least the piece of the audio data recorded, the emotion of the occupant being associated with the utterance made by the occupant in reply to the speech content;
a saving portion configured to save the piece of the audio data recorded and the emotion of the occupant recognized, the piece of the audio data being saved corresponding to the emotion of the occupant; and
a speech model generating portion configured to generate a speech model for outputting speech associated with an emotion of the occupant, on the basis of the audio data and emotions of the occupant saved with each piece of the audio data corresponding to one of the emotions.
